(19) United States
(12) Patent Application Publication
(10) Pub. No.: US 2008/0291709 A1
(43) Pub. Date: Nov. 27, 2008

(54) Switching power supply apparatus

(75) Inventor: Tokio Kawasaki, Osaka (JP)

Correspondence Address: BIRCH STEWART KOLASCH & BIRCH, PO BOX 747, FALLS CHURCH, VA, 22040-0747, US

(73) Assignee: SHARP KABUSHIKI KAISHA

(21) Appl. No.: 11/889,022

(22) Filed: Aug. 8, 2007

(30) Foreign Application Priority Data
Aug. 11, 2006 (JP) 2006-220569

(51) Int. Cl. H02M 7/155

(52) U.S. Cl. 363/77

(57) ABSTRACT

A switching power supply apparatus 10 controls a main switching element Q1 by a control circuit 12 so that a direct-current voltage obtained by rectifying an input alternating-current voltage is stabilized and outputted as a target direct current output. A starting current of the control circuit 12 is obtained via a first starting resistor R1 and a second starting resistor R2 from the direct-current voltage. Moreover, the switching power supply apparatus 10 includes a voltage detection circuit 14 and a switching circuit 13. The voltage detection circuit 14 detects a voltage of the direct current input with the use of a Zener diode ZD1. The switching circuit 13 stops the main switching element Q1 in a case where a voltage value of the direct current input becomes equal to or less than a predetermined value. The voltage detection circuit 14 detects a direct current voltage at a point connecting two of the plurality of starting resistors with the use of the Zener diode ZD1. This makes it possible to safely stop an operation of the switching power supply apparatus without erroneous operation or breakage of components in a case where an alternating-current voltage of a commercial power source for the switching power supply apparatus decreases.

This Nonprovisional application claims priority under U.S.C. § 119(a) on Patent Application No. 220569/2006 filed in Japan on Aug. 11, 2006, the entire contents of which are hereby incorporated by reference:

### FIELD OF THE INVENTION

The present invention relates to a switching power supply apparatus, particularly to a switching power supply apparatus which serves as a separate excitation type AC-DC converter including a control circuit that includes a starting circuit.

### BACKGROUND OF THE INVENTION

Conventionally, a switching power supply apparatus is known as an apparatus, capable of improving power conversion efficiency, which apparatus can be reduced in size and weight. In the switching power supply apparatus, current flowing in a secondary winding of a transformer is controlled by switching current flowing in a primary winding of the transformer, and thus voltage is converted. This makes it possible to improve conversion efficiency of the transformer and to reduce size and weight of the transformer. The switching power supply apparatus employs a separate excitation type switching control system including a control circuit for controlling the switching or a self commutated type switching control system that does not include the control circuit.

With reference to FIG. 5, explained is a first conventional example of a switching power supply apparatus employing the separate excitation type switching control system. A switching power supply apparatus 100 rectifies, with the use of a rectifying circuit composed of diodes D1 through D4 and a smoothing condenser C3, an alternating-current voltage Vin inputted between terminals P1 and P2 from a commercial power source so as to obtain a direct-current voltage. Then, the switching power supply apparatus 100 obtains an alternating-current voltage by switching, with the use of a main switching element Q1, the direct-current voltage thus obtained. This alternating-current voltage is applied to a primary main winding N1 of a transformer T1, and then an alternating-current voltage is outputted from a secondary winding N2 of the transformer T1. Consequently, the alternating-current voltage is outputted as a direct-current voltage from terminals P3 and P4 after the alternating-current voltage is converted to the direct-current voltage via a rectifying diode D6 and a smoothing condenser C5.

At this time, the direct-current voltage to be outputted from the terminals P3 and P4 can be stabilized by a control circuit (a control section) 102 provided. The control circuit 102 carries out PWM (Pulse Width Modulation) control with respect to the main switching element Q1, according to output voltage information fed back via a photo coupler PC from an output voltage detecting section 101 that detects the direct-current voltage of the secondary winding.

The switching power supply apparatus 100 uses the direct-current voltage as a power supply voltage VCC of the control circuit 102. This direct-current voltage is obtained by adjusting, with the use of starting resistors R1 and R2, the direct-current voltage rectified by the rectifying circuit composed of the diodes D1 through D4 and the smoothing condenser C3, when the switching power supply apparatus 100 starts its operation. When the output voltage is stabilized, the switching power supply apparatus 100 uses a direct-current voltage obtained by rectifying an alternating-current voltage from a primary sub-winding N3 (a sub-winding N3 provided on the same side as the primary main winding N1) of the transformer T1 with the use of a rectifying diode D7 and a smoothing condenser C4. The switching power supply apparatus 100 uses a plurality of the starting resistors R1 and R2 for the purpose of preventing a voltage applied between ends of each of the starting resistors R1 and R2 from exceeding a withstand voltage of the respective resistors R1 and R2.

The following explains a problem of the first conventional example with reference to the switching power supply apparatus 100 in FIG. 5 and FIG. 6(a). In the circuit as illustrated in FIG. 5, when the alternating-current voltage Vin from the commercial power source is turned off and accordingly a voltage of the smoothing condenser C3 starts to decrease, an output voltage from the terminal P3 also decreases. In addition, a voltage that occurs at the primary sub-winding N3 decreases at the same time. This decreases the power supply voltage VCC of the control circuit 102. As a result, the control circuit 102 temporarily stops the operation.

Then, due to an electric charge left over in the smoothing condenser C3, a current flows into the control circuit 102 via the starting resistors R1 and R2. This causes a rise in the power supply voltage VCC, as illustrated in FIG. 6(a). After some seconds from this rise, the control circuit 102 is activated and a pulse voltage occurs at the terminal P3. This causes a subsequently connected apparatuses to operate mistakenly. In a case where the switching power supply apparatus 100 is connected to, for example, an acoustic apparatus, a noise occurs from a speaker due to the pulse voltage. At this time, because the alternating-current voltage Vin of the commercial power source is kept off, the voltage of the P3 instantly decreases.

A second conventional example as illustrated in FIG. 7 solves the problem that occurs in the first conventional example. In a switching power supply apparatus 110 as in FIG. 7, a switching circuit 113 including a transistor Q2 is connected to a power supply voltage terminal VCC of a control circuit 112. When the alternating-current voltage Vin of a commercial power source abnormally decreases temporarily, a voltage of a smoothing condenser C3 becomes equal to or below a Zener voltage of Zener diodes ZD1 and ZD2 while the alternating-current voltage Vin is decreasing towards 0V. Accordingly, currents of the Zener diodes ZD1 and ZD2 become 0A. Consequently, a voltage at a cathode of a diode D5 becomes lower than a voltage at an anode of the diode D5, and the diode D5 becomes conductive. As a result, current flows into the earth via resistors R3 and R4. Because a base voltage of the transistor Q2 accordingly becomes lower than an emitter voltage thereof, the transistor Q2 is turned on. This causes current to flow into the earth through (i) a current limiting resistor R5 and (ii) an emitter and a collector of the transistor Q2. Consequently, the power supply voltage VCC of the control circuit 112 is reduced to approximately 0.2V and operation of the control circuit 112 is stopped. Therefore, as illustrated in FIG. 6(b), a pulse voltage does not occur at the terminal P3 in the second conventional example as illustrated in FIG. 7, when an electric power supply is turned off.

Patent Document 1 (Japanese Unexamined Utility Model Publication No. 55784/1993 (Jitsukaihei 5-55784) published on Jun. 23, 1993) discloses that the switching control element is turned off according to a result of comparing a reference voltage and an analog voltage obtained by converting, with the use of a pulse width detection circuit, an operating time of the switching element which operating time is increased by decrease in an input voltage at the time when a switching power supply is turned off.

The Zener diodes ZD1 and ZD2 used in the second conventional example as illustrated in FIG. 7 have an upper limit of the Zener voltage at approximately 36V. Because of the upper limit, the control circuit 112 stops its operation when the voltage applied to the smoothing condenser C3 becomes equal to or less than 72V. This voltage is approximately 50V if converted into an alternating-current voltage Vin of the commercial power source.

In the second conventional example, when the alternating-current voltage Vin decreases, an output voltage from the secondary winding N2 of the transformer T1 decreases. This decrease in the voltage is detected by the output voltage detecting section 111. The result of the detection is fed back to the control circuit 112 by a photo coupler PC. Then, the control circuit 112 increases a frequency of a switching signal outputted to a gate of the main switching element Q1 so as to increase the voltage to be outputted from the secondary winding N2 of the transformer T1. This increases the number of switchings per unit time of the main switching element Q1. This also increases a current flowing in a drain and a source of the main switching element Q1 in an inversely proportional manner with respect to the decrease of the voltage Vin. In addition, a current flowing in a fuse HS1 increases. Accordingly, the second conventional example holds a problem such that abnormal decrease of the alternating-current voltage Vin to 50V breaks down the main switching element Q1 or melts the fuse HS1. This problem occurs in the switching power supply apparatus 100 of the first conventional example as illustrated in FIG. 5 as well. Moreover, because of a low output impedance of a voltage that occurs at a terminal of the primary sub-winding 3 of the transformer T1, a current flowing into the transistor Q2 becomes large when the alternating-current voltage Vin decreases. This may break down the transistor Q2.

### SUMMARY OF THE INVENTION

The present invention is attained in view of the problems mentioned above. An object of the present invention is to provide a switching power supply apparatus that can safely stop operation in a case where an alternating-current voltage of a commercial power source decreases.

In order to achieve the object of the present invention, the switching power supply apparatus of the present invention which is a separate-excitation type and includes a control section for controlling a main switching element so that a direct current input is stabilized and outputted as a target direct current output, the switching power supply apparatus comprising: a starting power supply circuit including a plurality of starting resistors, which are connected to each other in series and generate a starting power source, causing the control section to start, in accordance with the direct current input; and a voltage detection switching circuit that detects via a Zener diode a voltage of the direct current input and causes the main switching element to stop operation when a voltage detected by the Zener diode becomes equal to or less than a predetermined voltage, the voltage detection switching circuit detecting via the Zener diode a direct-current voltage at a point connecting two of the plurality of starting resistors in the starting power supply circuit.

According to the arrangement, the voltage detection switching circuit detects a direct-current voltage at a point connecting two of a plurality of resistors in the starting circuit. This makes it possible to decrease a voltage of the direct current which is inputted into the voltage detection switching circuit and detected by the voltage detection switching circuit. Therefore, the arrangement makes it possible to use a Zener diode or a switching element whose withstand voltage is low. Moreover, the arrangement allows a circuit configuration to be simplified, because it becomes unnecessary to connect a plurality of Zener diodes in series for maintaining a sufficient withstand voltage as in a conventional arrangement.

Moreover, in the arrangement, a voltage of the direct current input is detected by the Zener diode. When the voltage becomes equal to or less than a predetermined value, the voltage detection switching circuit causes the control section to stop controlling the main switching element. This can prevent influence of a condenser used in a rectifying circuit that serves as an assistant power source to the control section. As a result, this can prevent breakage of the main transistor element which breakage occurs in the conventional arrangement or an adverse effect to other electronic apparatuses which effect is caused by the conventional arrangement.

For a fuller understanding of the nature and advantages of the invention, reference should be made to the ensuing detailed description taken in conjunction with the accompanying drawings.

### BRIEF DESCRIPTION OF THE DRAWINGS

FIG. 1 is a circuit diagram of a switching power supply apparatus of the Embodiment 1.

FIG. 2 is a circuit diagram of a switching power supply apparatus of the Embodiment 2.

FIG. 3 is a circuit diagram of a switching power supply apparatus of the Embodiment 3.

FIG. 4 is a circuit diagram of a switching power supply apparatus of the Embodiment 4.

FIG. 5 is a circuit diagram of a first example of a conventional switching power supply apparatus.

FIG. 6(a) is a waveform chart illustrating an operation of the first example of the conventional switching power supply apparatus.

FIG. 6(b) is a waveform chart illustrating (i) an operation of another conventional switching power supply apparatus that overcomes a conventional problem in the first example of the conventional switching power supply apparatus and (ii) an operation of a switching power supply apparatus of the present invention.

FIG. 7 is a circuit diagram of the another conventional switching power supply apparatus that conventionally solves the problem in the first example of the conventional switching power supply apparatus.

### DESCRIPTION OF THE EMBODIMENTS

### Embodiment 1

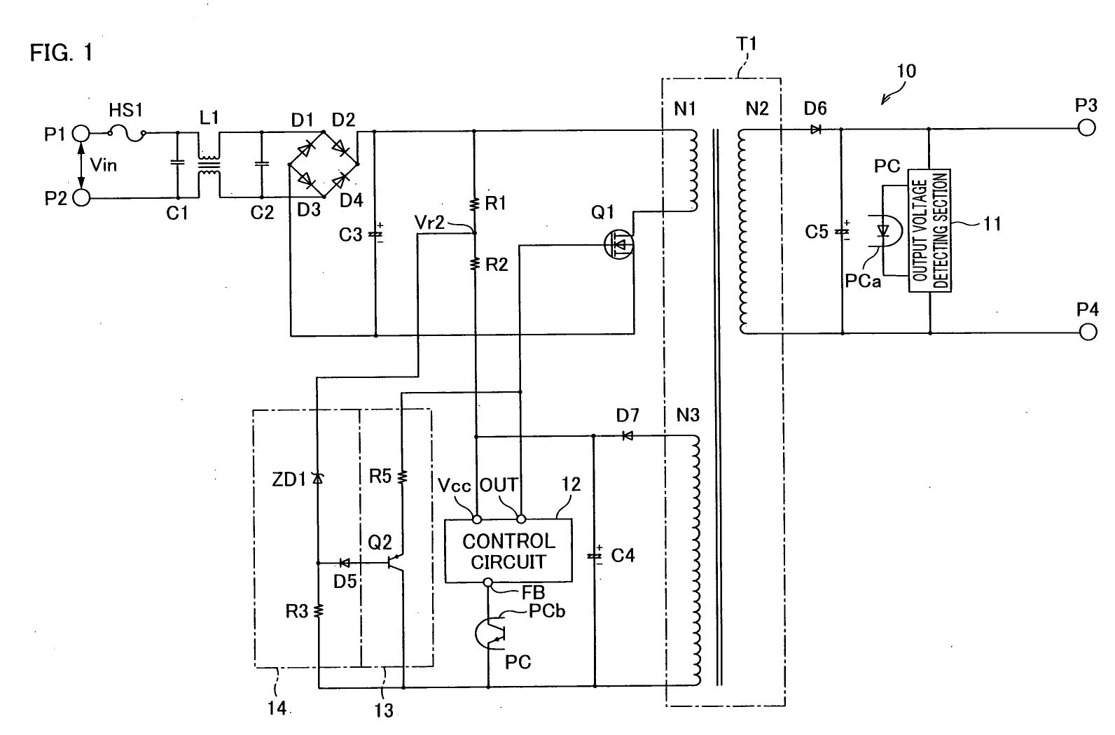

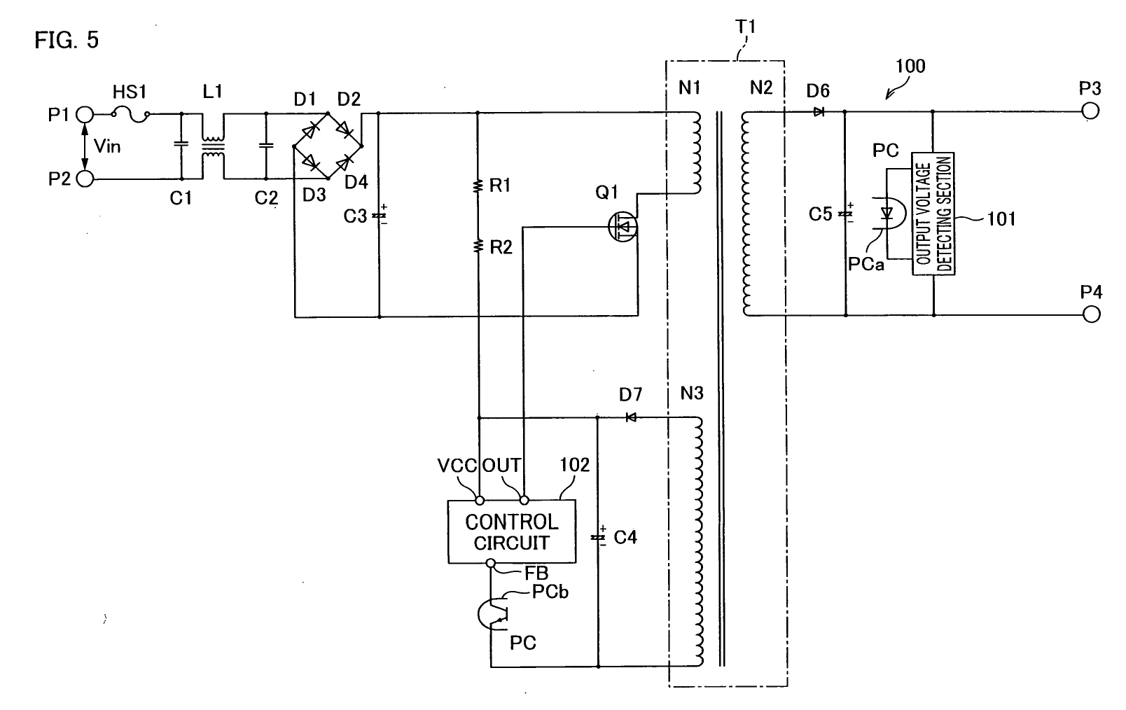

The following will describe an embodiment of a switching power supply apparatus, with reference to FIGS. 1 through 7. First, with reference to FIG. 1, explained is a schematic arrangement of a switching power supply apparatus according to the Embodiment 1. The switching power supply apparatus 10 as illustrated in FIG. 1 roughly includes an output voltage detecting section 11, a control circuit 12, a switching circuit 13, a voltage detection circuit 14, a transformer T1, a main switching element Q1, input terminals P1 and P2 to which an alternating-current voltage Vin is inputted, and direct-current voltage output terminals P3 and P4.

The switching power supply apparatus 10 further includes a line filter L1 and line condensers C1 and C2. The line filter L1 receives, via a fuse, an alternating-current voltage Vin, for example, a voltage that is 100V and 60 Hz, which is inputted between the terminals P1 and P2 from a commercial power source or the like. The line condensers C1 and C2 are connected to each other via the line filter L1 for the purpose of noise removal. A value of the alternating-current voltage of the commercial power source is, for example, 117V, 200V, or 220V, other than 100V.

The switching power supply apparatus 10 includes the diodes D1 through D4 provided in a Wheatstone bridge form and a smoothing condenser C3. An alternating current input whose noise from the line filter L1 is removed is inputted to the diodes D1 through D4. The smoothing condenser C3 further rectifies a direct current having a ripple component from the diodes D1 through D4 and outputs a direct current input thus obtained from the alternating current input. Moreover, the switching power supply apparatus 10 includes the transformer T1 that includes (i) a primary main winding N1 which receives the direct current input from the smoothing condenser C3, (ii) a secondary winding N2 which has an opposite polarity with respect to that of the primary main winding N1, and (iii) a primary sub-winding N3 which serves as an assistant power source. The primary sub-winding N3 is formed to have a polarity in a forward direction with respect to the polarity of the primary main winding N1.

The switching power supply apparatus 10 is further provided with the Field Effect Transistor (FET) (main switching element) Q1 that is connected to the primary main winding N1 of the transformer T1 and carries out switching (intermittent connection) of current flowing in the first primary winding N1. The FET Q1 converts the direct current input to an alternating current having a predetermined frequency so that a load voltage which is to be applied to a load is set to a target voltage.

In the present embodiment, the FET Q1 is an N-channel type. However, according to need, the FET Q1 may be P-channel type. Moreover, another type of a transistor, for example, a bipolar transistor can be used as long as the transistor includes a switching function. A drain of the FET Q1 is connected to earth of the primary main winding N1 and a source of the FET Q1 is connected to earth of the diodes D1 through D4. A gate of the FET Q1 is connected to an output terminal OUT of the control circuit 12 later explained and one end of a current limiting resistor R5 for a transistor Q2 in the switching circuit 13.

The secondary winding N2 of the transformer T1 is provided with a rectifying diode D6, a smoothing condenser C5, and output terminals P3 and P4. The rectifying diode D6 (i) rectifies an output alternating current, whose voltage is increased/decreased and adjusted to a target voltage, outputted from the secondary winding N2 and (ii) outputs the output alternating current as a direct current output. The output terminals P3 and P4 output the direct current output to the outside. The output voltage detecting section 11 connected in parallel to the output terminals P3 and P4 is also provided to the secondary winding N2 so as to detect a voltage of the direct current output. The secondary winding N2 of the transformer T1 is further provided with a light emitting section PCa of a photo coupler PC that sends a value of the output voltage detected by the output voltage detecting section 11 to a side provided with the primary winding N1 by means of non-contact optical transmission.

The control circuit 12 is a control IC that can carry out, for example, PWM control. In the control carried out by the control circuit 12, a detection signal, from the light receiving section PCb of the photo coupler PC, which indicates a value of the voltage outputted is inputted into a feedback terminal FB. Then, in accordance with the detection signal, the control circuit 12 changes a control signal (a switching pulse signal) supplied to the gate of the FET Q1, in other words, changes switching operation of the FET Q1, i.e. a switching frequency or a duty ratio of the switching pulse signal.

The primary sub-winding N3 of the transformer T1 is provided with a rectifying diode D7 and the smoothing condenser C4 so that a direct-current voltage at a predetermined voltage is supplied as an assistant power source to the power supply terminal Vcc of the control circuit 12. The smoothing condenser C4 serves as a rectifying condenser and a storage condenser in which a starting current from starting resistors R1 and R2 is stored at the time of starting the operation of the power supply apparatus 10.

The power supply terminal Vcc of the control circuit 12 is also supplied with a direct-current voltage at a predetermined voltage which direct-current voltage is generated from a direct current input from the diodes D1 through D4 via the starting resistors R1 and R2, for the purpose of starting the control circuit 12.

The switching power supply apparatus 10 further includes the switching circuit 13 and the voltage detection circuit 14. The switching circuit 13 is composed of a resistor R5 and the transistor Q2 which are connected in series. One end of the switching circuit 13 (a side provided with the resistor R5) is connected to a point connecting the output of the control circuit 12 and the gate of the FET Q1. The other end (a side provided with the transistor Q2) of the switching circuit 13 is connected to earth.

The voltage detection circuit 14 includes a Zener diode ZD1, a resistor R3, and a diode D5. In the voltage detection circuit 14, the Zener diode ZD1 and the resistor R3 are connected in series. A cathode of the diode D5 is connected to a point connecting the Zener diode ZD1 and the resistor R3. The other end of the Zener diode ZD1 is connected to a point connecting the starting resistors R1 and R2, and the other end of the resistor R3 is connected to earth. A base of the transistor Q2 in the switching circuit 13 is connected to an anode of the diode D5 in the voltage detection circuit 14.

When the switching power supply apparatus 10 stops its operation and the alternating-current voltage Vin is turned off, a voltage applied between the ends of the smoothing condenser C3 become equal to or less than a Zener voltage of the Zener diode ZD1 in the course of a decrease of the alternating-current voltage Vin towards 0V. As a result, the current of the Zener diode ZD1 becomes 0A. Accordingly, a voltage at the cathode of the diode D5 becomes lower than that of the anode, and the diode D5 becomes conductive. Consequently, a current flows into earth via the resistor R3. Subsequently, a base voltage of the transistor Q2 becomes lower than an emitter voltage thereof, and the transistor Q2 is turned on. This stops switching operation of the FET Q1 because the switching signal that is outputted to the gate of the FET Q1 flows into earth through the current limiting resistor R5 and the emitter/collector of the transistor Q2. This safely stops operation of the switching power supply apparatus 10.

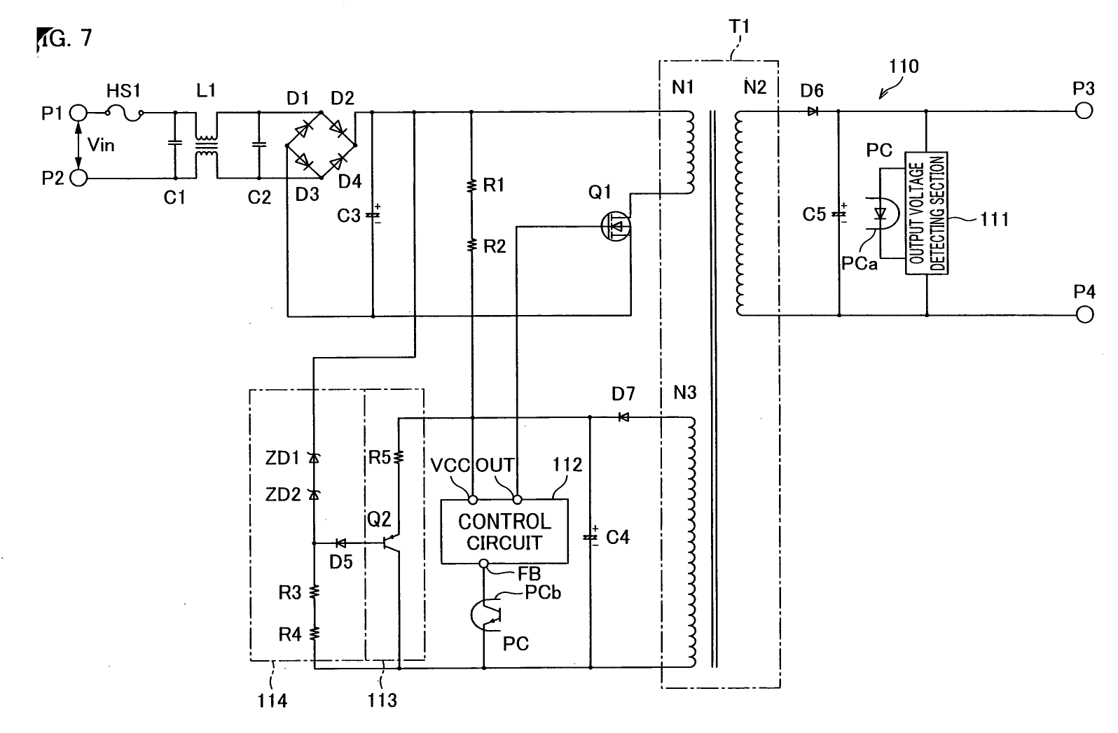

Moreover, due to connection of the voltage detection circuit 14 to a point connecting the starting resistors R1 and R2, the input voltage that is applied to the voltage detection circuit 14 is divided by the starting resistors R1 and R2 to a voltage which is lower than that of the second conventional example as illustrated in FIG. 7. This decreases the input voltage applied to the voltage detection circuit 14, namely, a Zener voltage of the Zener diode ZD 1, when the control circuit 12 stops the operation. Therefore, the Zener diode ZD2 as illustrated in FIG. 7 can be removed in the voltage detection circuit 14. Moreover, it also becomes possible to remove the resistor R4 from the resistors R3 and R4, as illustrated in FIG. 7, which are resistors each having a half watt rated power consumption, because power consumption of the resistors R3 and R4 is decreased.

Moreover, it is preferable to make the settings of the starting resistors R1 and R2 according to the following equation (1):

R1/R2=((Vin√2×k)−Vcc)/(Vzd1−Vcc)−1 (1)

where: the alternating-current voltage Vin indicates the alternating-current voltage that is inputted into the terminals P1 and P2; the Vzd1 indicates a Zener voltage of the Zener diode ZD1; and the Vcc indicates a power supply voltage of the control circuit 12. The same setting is preferable in other embodiments explained later.

The equation (1) can be drawn from (i) a fact in which a voltage Vr2 at the point connecting the starting resistors R1 and R2 satisfies an equation (R2/R1+R2)×(Vin×√2×k−Vcc)+Vcc and (ii) a fact in which the voltage Vr2 at the time when the transistor Q2 is turned on and the control circuit 12 stops the operation becomes equal to the Zener voltage Vzd1 of the Zener diode ZD1. k is a coefficient for stopping the switching operation of the FET Q1. The switching operation of the FET Q1 is stopped by absorbing, with the use of the transistor Q2 of the switching circuit 13, a switching signal outputted to the gate of the FET Q1 from the control circuit 12 when the alternating-current voltage Vin decreases to, for example, 70% thereof. It is possible to optionally set a voltage at which the switching operation is stopped by varying this value k. In a case where the switching operation is stopped at the time when the alternating-current voltage decreases to 70%, k is equal to 0.7.

### Embodiment 2

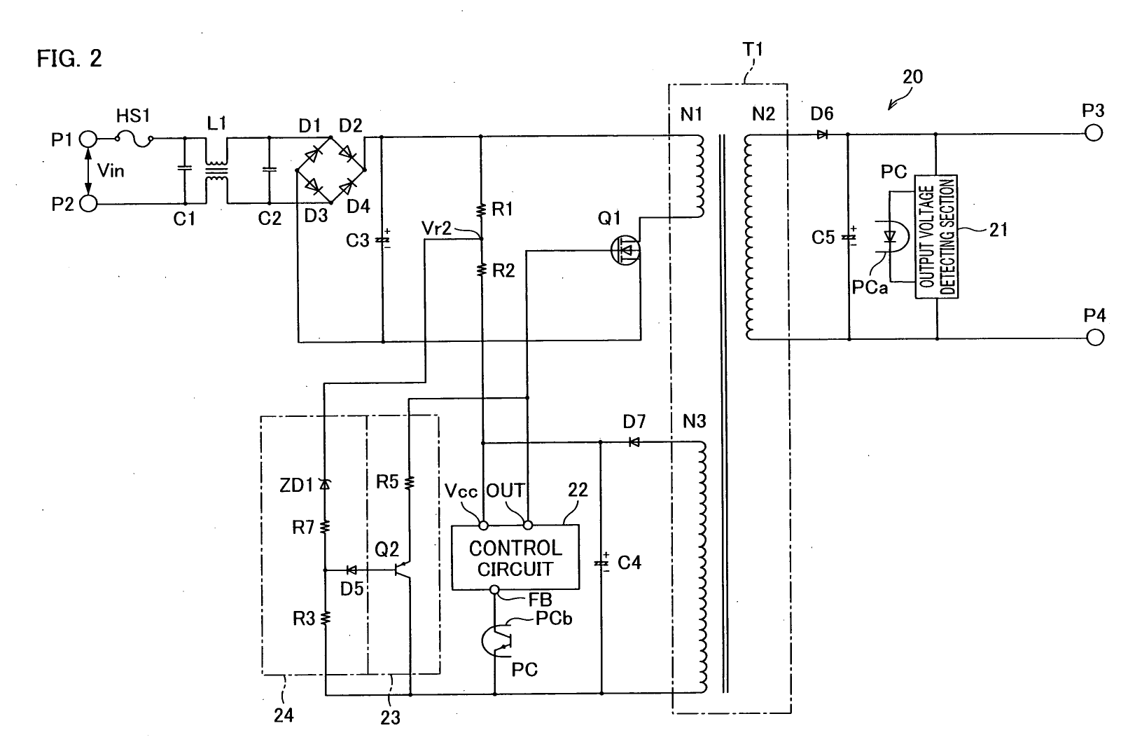

With reference to FIG. 2, another embodiment of the present invention is explained below.

A switching power supply apparatus 20 as illustrated in FIG. 2 is provided with a voltage detection circuit 24 in which a second bias resistor R7 is additionally provided in series between (i) a Zener diode ZD1 and (ii) a first bias resistor R3 and a diode D5 in an arrangement of a voltage detection circuit 14 as in FIG. 1. This addition of the second bias resistor R7 decreases a cathode voltage of the diode D5 because the voltage is divided and attenuated by the resistors R3 and R7. Conventionally, a diode having a withstand voltage of 500V is used as the diode D5. However, in an arrangement as illustrated in FIG. 2, the switching power supply apparatus 20 can use, as the diode D5, a diode, having a withstand voltage of 50V, which is low in a withstand voltage, low in cost, and small in size.

### Embodiment 3

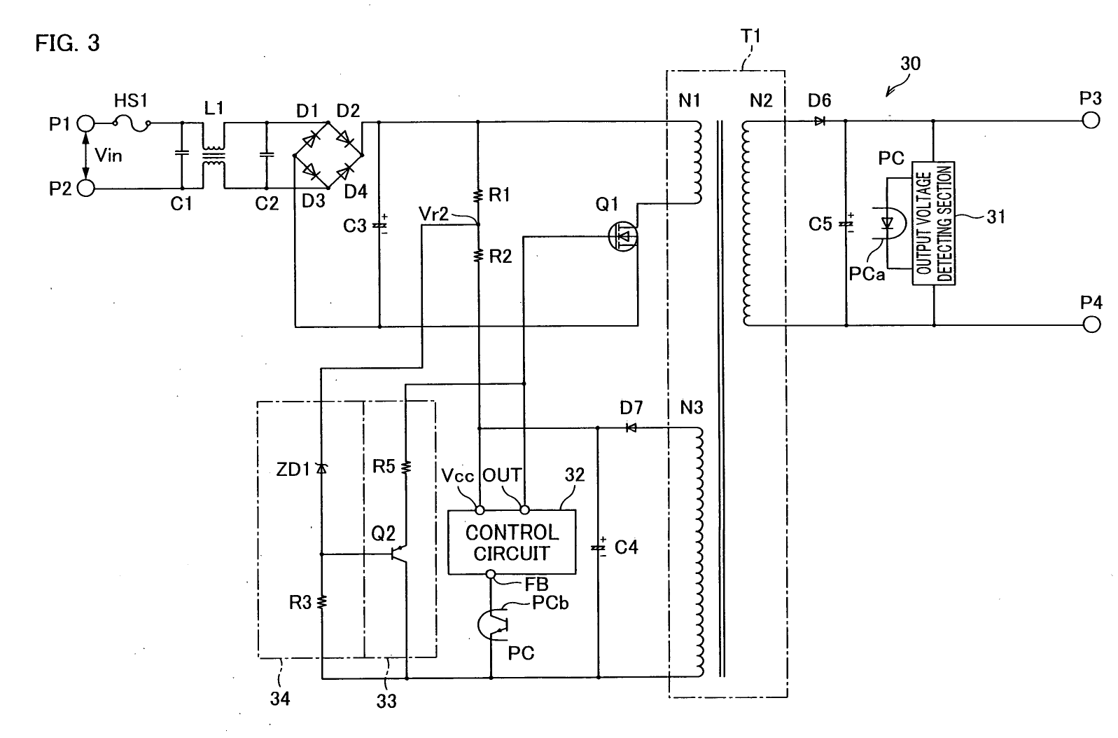

With reference to FIG. 3, a yet another embodiment of the present invention is explained below.

A switching power supply apparatus 30 as illustrated in FIG. 3 is provided with a voltage detection circuit 34 in which a diode D5 is removed from an arrangement of a voltage detection circuit 14 as in FIG. 1. In this arrangement, connection of the voltage detection circuit 34 to a point connecting starting resistors R1 and R2 makes it possible to decrease an input voltage applied to the voltage detection circuit 34, compared with an input voltage applied to a voltage detection circuit 114 of a second conventional example as in FIG. 7. As a result, a base voltage of the transistor Q2 can be set low. This makes it possible to remove the diode D5 by using, as the transistor Q2, a transistor whose withstand voltage of the base voltage is 100V.

### Embodiment 4

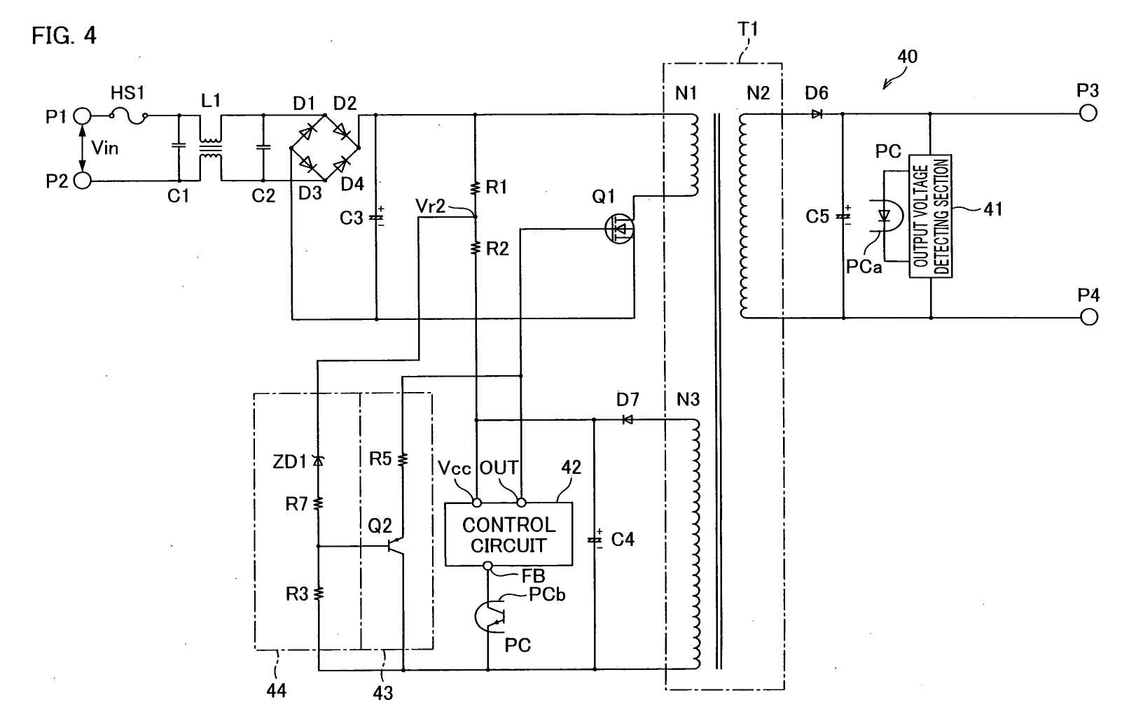

With reference to FIG. 4, a still yet another embodiment of the present invention is explained below.

The switching power supply apparatus 40 as illustrated in FIG. 4 is provided with a voltage detection circuit 44 in which the diode D5 is removed from an arrangement of the voltage detection circuit 24 as illustrated in FIG. 2. In this arrangement, the base voltage of the transistor Q2 is divided and attenuated by the second bias resistor R7 and the first bias resistor R3. As a result, it becomes possible to use, as the transistor Q2, a transistor whose withstand voltage of the base voltage is approximately 80V, which transistor is lower in the withstand voltage and cost than the transistor, as used in the embodiment 3, whose withstand voltage of the base voltage is 100V.

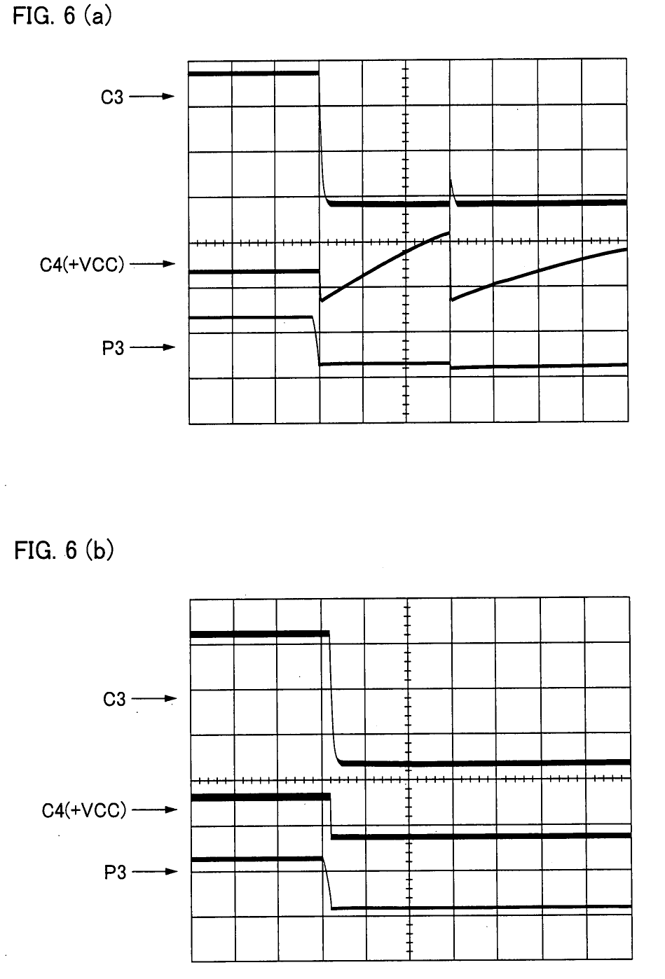

In any one of the Embodiments 1 through 4 above, as illustrated in FIG. 6(b) showing an operation of the switching power supply apparatus, a pulse voltage from the terminal P3 stops after the alternating-current voltage of the commercial power source is turned off. Moreover, it becomes possible to stop operation of the control circuit at the time when the alternating-current voltage of the commercial power source decreases to k×100%. This makes it possible to stop an operation of the switching power supply apparatus safely without erroneous operation or breakage or damage to other components. Furthermore, because a gate switching signal of the FET Q1 has a relatively high impedance, a large current does not flow in the transistor Q2. Accordingly, the possibility of breakage of the transistor Q2 is eliminated.

In the switching power supply apparatus of the present embodiment, the voltage detection switching circuit may include a switching element that operates and outputs a signal for stopping the operation of the main switching element, in accordance with a voltage detected by the Zener diode.

In the switching power supply apparatus of the present embodiment: the switching element may be a transistor; and the voltage detection switching circuit may include, between the Zener diode and the transistor, a diode for protecting the transistor.

According to the arrangement, the provision of the diode for protecting a transistor makes it possible to decrease a withstand voltage of the transistor used as the switching element. This makes it possible to reduce cost and size of the switching power supply apparatus.

In the switching power supply apparatus of the present embodiment, the voltage detection switching circuit may include a first bias resistor for the Zener diode.

According to the above-mentioned arrangement, because the voltage detection switching circuit includes a first bias resistor, it becomes possible to use a Zener diode having a low withstand voltage. This makes it possible to reduce cost and size of the switching power supply apparatus.

In the switching power supply apparatus of the present embodiment, the voltage detection switching circuit may include a second bias resistor, which divides and attenuates a voltage applied to the voltage detection switching circuit.

According to the above-mentioned arrangement, because the voltage detection switching circuit further includes the second bias resistor, it becomes possible to use a Zener diode having a lower withstand voltage. Consequently, this makes it possible to reduce cost and size of the switching power supply apparatus.

In the switching power supply apparatus of the present embodiment, the voltage detection switching circuit may include a current limiting resistor for preventing an overcurrent.

The switching power supply apparatus of the present embodiment may further include an input-side rectifying circuit for converting an alternating current input into the direct current input.

In the switching power supply apparatus of the present embodiment, a ratio (R1/R2) of a resistance of a first starting resistor to a resistance of a second starting resistor in the starting power supply circuit may be set based on the following equation:

R1/R2=((Vin√2×k)−Vcc)/(Vzd1−Vcc)−1 (1)

where: the Vin indicates an alternating current input voltage; the Vzd1 indicates a Zener voltage of a Zener diode; the Vcc indicates a power supply voltage of the control section; and the k indicates a set value of a decreasing rate of the alternating current input voltage, the set value being set for temporarily stopping control of the control section, the first and second resistors being connected with each other via a connecting point whose voltage is detected.

The embodiments and concrete examples of implementation discussed in the foregoing detailed explanation serve solely to illustrate the technical details of the present invention, which should not be narrowly interpreted within the limits of such embodiments and concrete examples, but rather may be applied in many variations within the spirit of the present invention, provided such variations do not exceed the scope of the patent claims set forth below.

What is claimed is:

1. A switching power supply apparatus which is a separate-excitation type and includes a control section for controlling a main switching element so that a direct current input is stabilized and outputted as a target direct current output, the switching power supply apparatus comprising:
a starting power supply circuit including a plurality of starting resistors, which are connected to each other in series and generate a starting power source, causing the control section to start, in accordance with the direct current input; and
a voltage detection switching circuit that detects via a Zener diode a voltage of the direct current input and causes the main switching element to stop operation when a voltage detected by the Zener diode becomes equal to or less than a predetermined voltage,
the voltage detection switching circuit detecting via the Zener diode a direct-current voltage at a point connecting two of the plurality of starting resistors in the starting power supply circuit.

2. The switching power supply apparatus as set forth in claim 1, wherein:
the voltage detection switching circuit includes a switching element that operates and outputs a signal for stopping the operation of the main switching element, in accordance with a voltage detected by the Zener diode.

3. The switching power supply apparatus as set forth in claim 2, wherein:
the switching element is a transistor; and
the voltage detection switching circuit includes, between the Zener diode and the transistor, a diode for protecting the transistor.

4. The switching power supply apparatus as set forth in claim 1, wherein:
the voltage detection switching circuit includes a first bias resistor for the Zener diode.

5. The switching power supply apparatus as set forth in claim 4, wherein:
the voltage detection switching circuit includes a second bias resistor, which divides and attenuates a voltage applied to the voltage detection switching circuit.

6. The switching power supply apparatus as set forth in claim 1, wherein:
the voltage detection switching circuit includes a current limiting resistor for preventing an overcurrent.

7. The switching power supply apparatus as set forth in claim 1, further comprising:
an input-side rectifying circuit for converting an alternating current input into the direct current input.

8. The switching power supply apparatus as set forth in claim 7, wherein:
a ratio (R1/R2) of a resistance of a first starting resistor to a resistance of a second starting resistor in the starting power supply circuit is set based on the following equation:
R1/R2=((Vin√2×k)−Vcc)/(Vzd1−Vcc)−1 (1)
where:
the Vin indicates an alternating current input voltage;
the Vzd1 indicates a Zener voltage of a Zener diode;
the Vcc indicates a power supply voltage of the control section; and
the k indicates a set value of a decreasing rate of the alternating current input voltage, the set value being set for temporarily stopping control of the control section,
the first and second resistors being connected with each other via a connecting point whose voltage is detected.
